(19) United States
(12) Patent Application Publication
(10) Pub. No.: US 2024/0347758 A1
(43) Pub. Date: Oct. 17, 2024

(54) BATTERY MODULE

(71) Applicant: FCA US LLC, Auburn Hills, MI (US)

(72) Inventors: Tae Hyun Kim, Troy, MI (US); Davide Giubellino, Torino (IT)

(21) Appl. No.: 18/301,472

(22) Filed: Apr. 17, 2023

(51) Int. Cl. H01M 10/04; H01M 50/204

(52) U.S. Cl. CPC H01M 10/0481; H01M 50/204; H01M 2220/20

(57) ABSTRACT

A method of manufacturing a solid-state battery module includes providing a housing, providing a solid-state battery cell stack, and pre-compressing the solid-state battery cell stack. The method further includes inserting, while pre-compressed, the solid-state battery cell stack into the housing, and releasing the pre-compression of the inserted pre-compressed solid-state battery cell stack such that the solid-state battery cell stack expands to establish a compression fit within the housing.

### FIELD

The present application relates generally to battery modules and, more particularly, to a compression housing and method for solid-state battery modules for electric vehicles.

### BACKGROUND

Solid state battery technology is a promising technology that could potentially replace conventional liquid electrolyte type batteries by providing improved battery performance with high energy density and improved thermal characteristics. To achieve such high performance, it is critical to maintain high compression between the solid electrolyte and the electrodes to mitigate any potential delamination or void issues that can potentially result in issues at the interface due to high resistance and propagation of dendrites. The desired compression, which may be an order of magnitude higher than any compression required of conventional liquid electrolyte batteries, is not achievable using existing module design approaches. Accordingly, while conventional liquid battery modules work well for their intended purpose, there is a desire for improvement in the relevant art.

### SUMMARY

In accordance with one example aspect of the invention, a method of manufacturing a solid-state battery module is provided. The method includes providing a housing, providing a solid-state battery cell stack, and pre-compressing the solid-state battery cell stack. The method further includes inserting, while pre-compressed, the solid-state battery cell stack into the housing, and releasing the pre-compression of the inserted pre-compressed solid-state battery cell stack such that the solid-state battery cell stack expands to establish a compression fit within the housing.

In addition to the foregoing, the described method may include one or more of the following features: attaching a reinforcement cover to the housing to facilitate enclosing and protecting the solid-state battery cell stack and providing additional structural rigidity to the housing wherein said attaching the reinforcement cover includes inserting a flange of the reinforcement cover into a slot formed in the housing; and wherein said attaching the reinforcement cover includes attaching a top reinforcement cover to a top side of the housing, and attaching a bottom reinforcement cover to a bottom side of the housing.

In addition to the foregoing, the described method may include one or more of the following features: arranging one or more spacer plates against an end of the solid-state battery cell stack before said pre-compressing the solid-state battery cell stack, wherein the one or more spacer plates have a chosen thickness to accommodate manufacturing variability in the solid-state battery cell stack and/or a thickness of the housing; wherein the solid-state battery cell stack is pre-compressed with a pressure between approximately 1.0 MPa and approximately 3.0 MPa; wherein said pre-compressing is performed with a plurality of assembly rods and/or assembly beams squeezing opposite sides of the solid-state battery cell stack; and wherein the housing includes a plurality of cutouts configured to provide clearance to the plurality of assembly rods and/or assembly beams such that the housing can be inserted over the solid-state battery cell stack while being pre-compressed.

In accordance with another example aspect of the invention, a solid-state battery module is provided. In one example, the solid-state battery module includes a housing and a pre-compressed solid-state battery cell stack, wherein the pre-compressed solid-state battery cell stack is disposed within the housing in an expanded, compression fit with the housing.

In addition to the foregoing, the described solid-state battery module may include one or more of the following features: wherein the solid-state battery cell stack comprises a plurality of battery cells separated by a plurality of compression pads; a reinforcement cover coupled to the housing to facilitate enclosing and protecting the solid-state battery cell stack and providing additional structural rigidity to the housing; wherein the reinforcement cover includes a flange configured to be inserted into a slot formed in the housing when attaching the reinforcement cover to the housing; and wherein the reinforcement cover includes a top reinforcement cover coupled to a top side of the housing, and a bottom reinforcement cover coupled to a bottom side of the housing.

In addition to the foregoing, the described solid-state battery module may include one or more of the following features: a pair of spacer plates arranged on opposite sides of the solid-state battery cell stack, wherein the spacer plates have a chosen thickness to accommodate manufacturing variability in the solid-state battery cell stack and/or a thickness of the housing; wherein the solid-state battery cell stack is pre-compressed with a pressure between approximately 1.0 MPa and approximately 3.0 MPa, and wherein the housing provides the support to maintain a compression of the pre-compressed solid-state battery cell stack; and wherein the housing includes a plurality of cutouts configured to provide clearance to a plurality of assembly rods and/or assembly beams such that the housing can be inserted over the solid-state battery cell stack while being pre-compressed.

In addition to the foregoing, the described solid-state battery module may include one or more of the following features: wherein the plurality of assembly rods and/or assembly beams squeeze opposite sides of the solid-state battery cell stack to pre-compress the solid-state battery cell stack; wherein the housing is a one-piece frame fabricated from a rigid material, and wherein the housing includes a first pair of opposed walls coupled between a second pair of opposed walls to form a generally rectangular housing configured to receive the pre-compressed solid-state battery cell stack; and wherein the solid-state battery module does not require any fasteners.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a perspective view of an example partially assembled solid-state battery module in accordance with the principles of the present application;

FIG. 2 is another perspective view of the partially assembled solid-state battery module shown in FIG. 1, in accordance with the principles of the present application;

FIG. 3 is yet another perspective view of the partially assembled solid-state battery module shown in FIG. 1, in accordance with the principles of the present application;

FIG. 4 is a perspective view of the assembled solid-state battery module, in accordance with the principles of the present application;

FIG. 5A is a schematic side view of an example assembly process of the solid-state battery module shown in FIG. 1, in accordance with the principles of the present application;

FIG. 5B is another schematic side view of the solid-state battery module shown in FIG. 5A, in accordance with the principles of the present application; and

FIG. 6 illustrates an example method of manufacturing the solid-state battery module shown in FIG. 4, in accordance with the principles of the present application.

### DETAILED DESCRIPTION

According to the principles of the present application, systems and methods are described for a solid-state battery module. In one example, the module includes a box frame structure housing a compressed stack of solid-state cells and compression pads. One or more spacer plates or pads are disposed at each end of the cell stack, and the entire stack is pre-compressed to a desired pre-compression via one or more assembly beams or rods at each end. Slots in compression faces of the box frame structure allow the box frame structure to be placed over the compressed cell stack with the assembly rods in place. The assembly rods are then slowly released for the stack to expand and compression fit inside the box frame structure to achieve the desired compression of the cell stack.

Accordingly, a single piece, solid structure box frame formed from a rigid material (e.g., aluminum casting, composite material, etc.) is provided with sufficient wall thickness and structural ridges to allow a compression fit of a cell stack inside to achieve the desired level of compression. A stack of cells can be pre-compressed and then press-fit into the box frame structure, or they can be pre-compressed and then the box frame structure with slots in the compression faces is lowered down and the stack released inside the box frame structure. The assembly mechanism and slots in the compression face can be multiple in numbers and spread across the compression face to minimize stress concentration. Additional spacer plates may be utilized at both ends of the stack to come into contact with the assembly rods during pre-compression of the stack. The thickness of the spacer plates can be chosen to control the final compression to account for various manufacturing tolerances of cells and the box frame structure.

The described battery module provides a structurally rigid solution for the high compression environments expected of the solid-state battery. No moving parts or assembly fasteners (e.g., bolts, studs, etc.) are required to apply the compression, thereby providing a simple and elegant structure and assembly process. Control over the final compression in the assembly can be achieved with a selection of spacer plates to achieve the desired compression. Mounting bosses can be integrated into the box frame structure design to fix the module down to a battery pack or vehicle frame. However, it will be appreciated that the battery module described herein may be utilized with various other system besides electric vehicles. The aspect ratio of the box frame structure can accommodate both long and short cell length. For a long cell length configuration, a reinforcement of the module with rigid top and bottom covers can be added for structural rigidity while promoting extra cell protection. Various aperture patterns on the covers minimize mass while providing sufficient strength at the top and bottom of the box frame structure.

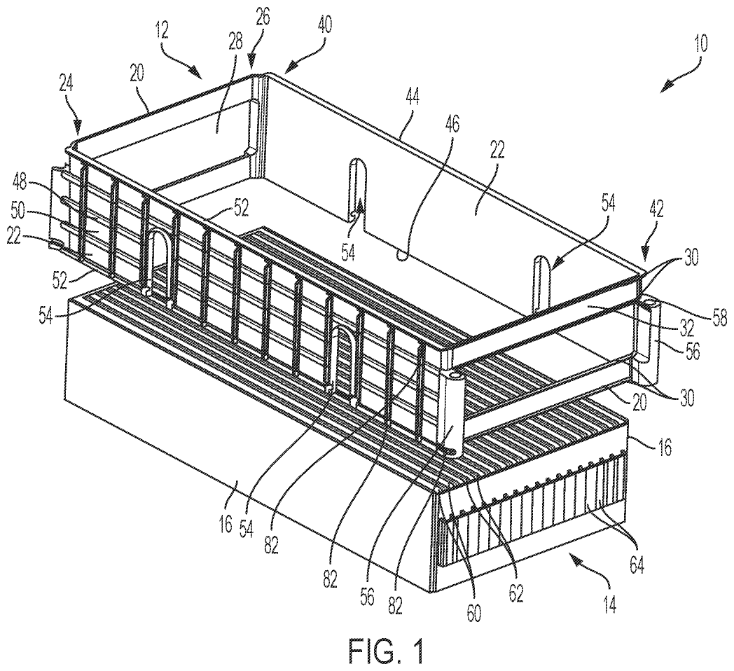

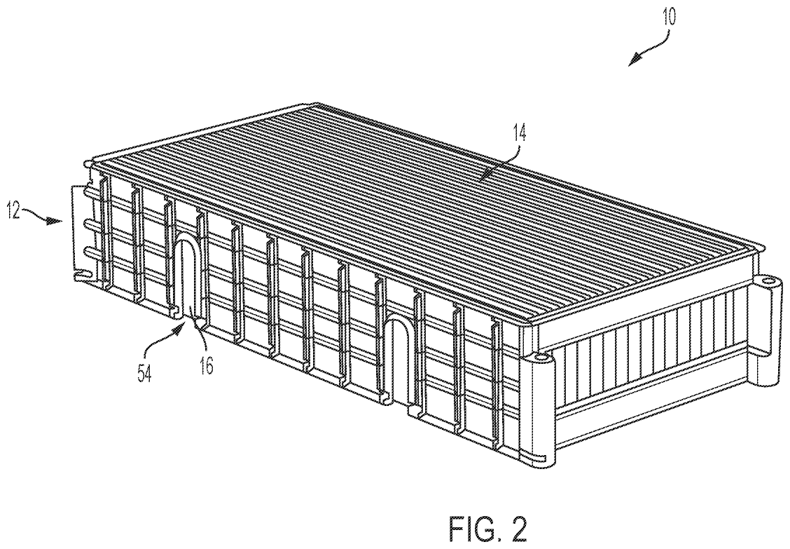

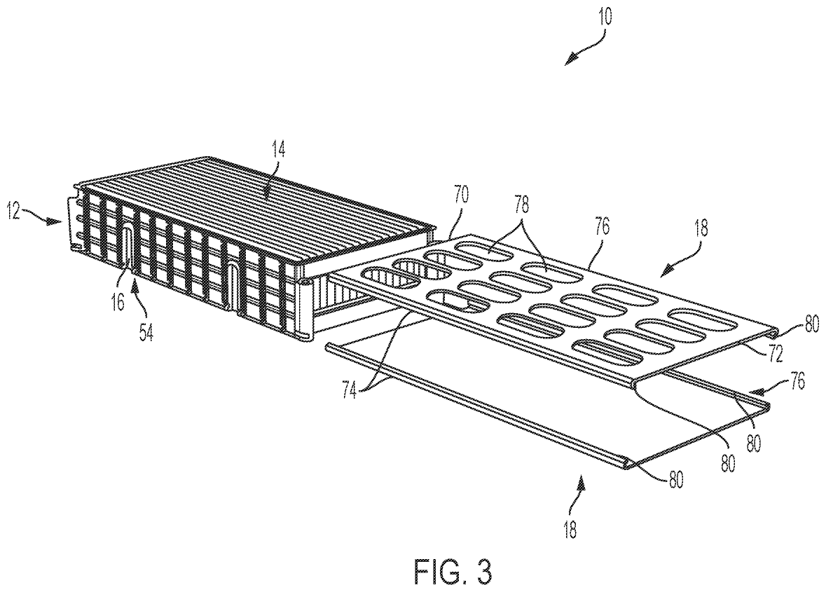

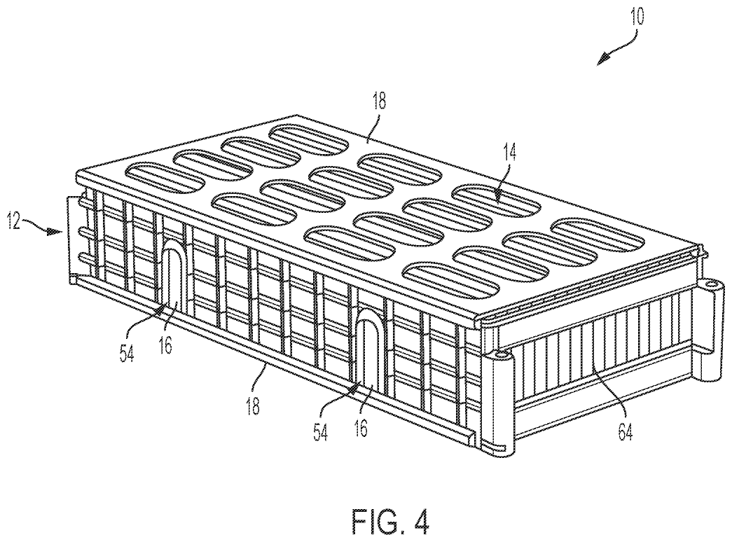

With initial reference to FIGS. 1-4, a solid-state battery module (SSBM) 10 is illustrated in accordance with the principles of the present disclosure. In the example embodiment, the SSBM 10 generally includes a box frame structure or housing 12, a solid-state battery cell stack 14, one or more spacer plates 16, and a pair of reinforcement covers 18. FIG. 1 illustrates the battery cell stack 14 and spacer plates 16 before insertion into the housing 12. FIG. 2 illustrates the battery cell stack 14 and spacer plates 16 after being pre-compressed and inserted into the housing 12. FIG. 3 illustrates covers 18 positioned for attachment to the housing 12 to enclose the battery cell stack 14 and spacer plates 16 therein. FIG. 4 illustrates the assembled SSBM 10.

With continued reference to FIG. 1, in the example embodiment, housing 12 generally includes a first pair of opposed walls 20 extending between a second pair of opposed walls 22 to form a generally rectangular box frame structure. In one example, housing 12 is a one-piece frame fabricated from a rigid material (e.g., aluminum, steel, high strength composite, etc.), for example, via cold stamping, injection molding, or other suitable manufacturing process. However, it will be appreciated that housing 12 may be formed from a plurality of separate components (e.g., walls) subsequently joined by a suitable connecting process (e.g., welding).

In the example embodiment, the walls 20, 22 have a sufficient predefined thickness to enable housing 12 to rigidly support a pre-compressed battery cell stack 14 at a predefined final compression force. In one example, the walls 20, 22 each have a thickness of between 1.0 mm and 3.0 mm, or between approximately 1.0 mm and approximately 3.0 mm. However, it will be appreciated that walls 20, 22 may have any suitable thickness that enables SSBM 10 to function as described herein.

In the illustrated example, each wall 20 includes a first end 24 and an opposite second end 26. The first end 24 is coupled to an end of one wall 22, while the other end 26 is coupled to an end of the other wall 22. In some examples, like the one shown, one or more portions of the wall 20 are removed, for example to reduce weight while still providing a desired structural rigidity, thereby resulting in one or more windows or apertures 28. Edges of the remaining material may include a ridge or flange 30 to increase strength and rigidity of the wall 20. In one example, flanges 30 extend perpendicular to or substantially perpendicular to a planar surface 32 of the wall 20.

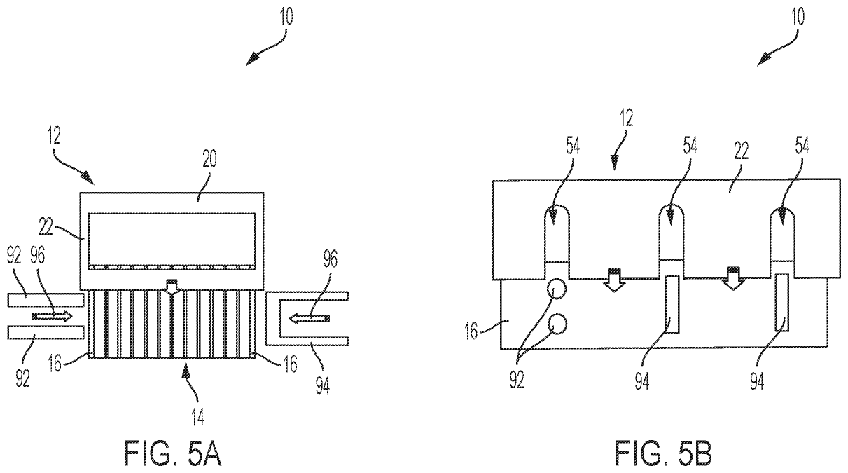

In the example embodiment, each wall 22 includes a first end 40, an opposite second end 42, a first or top edge 44, and an opposite second or bottom edge 46. The first end 40 is coupled to an end of one wall 20, while the other end 42 is coupled to an end of the other wall 20. Although not shown, one or more portions of the wall 22 may be removed, for example to reduce weight while still providing a desired structure rigidity. To increase structural rigidity, structural flanges or ribs 48 may be formed (e.g., stamped) into an outer surface 50 of each wall 22. In the illustrated example, the structural ribs 48 form a generally square or rectangular pattern in the outer surface 50. Additionally, the top and bottom edges 44, 46 may include a flange 52 to increase strength and rigidity of the wall 22. In one example, flanges 52 extend perpendicular to or substantially perpendicular to the outer surface 50 of the wall 22. Moreover, in the example embodiment, walls 22 include one or more slots or cutouts 54 formed therein to receive assembly machine components, as described herein in more detail in the discussion of FIGS. 5A-5B.

In the illustrated example, the housing 12 further includes integrated mounting bosses 56 located at each corner to provide increased structural rigidity and to enable the SSBM 10 to be coupled to another SSBM, a battery pack, a vehicle frame, or other vehicle component. As shown, each mounting boss 56 includes one or more apertures 58 extending at least partially through an axial extension of the mounting boss 56. In this way, aperture 58 is configured to receive a mounting/locating post (not shown) therein for attachment to the other component.

With continued reference to FIG. 1, the solid-state battery cell stack 14 generally includes a plurality of cells 60 separated by compression pads 62. Each cell 60 can have various configurations known to those skilled in the art. For example, although not shown in detail, each single solid-state type cell 60 can generally include a solid-state separator (e.g., ceramic or solid polymer electrolyte) disposed between a first electrode (e.g., cathode) and a second electrode (e.g., anode). In one example, cell 60 may be lithium-ion and include an anode of pure lithium metal. Each compression pad 62 is configured to absorb contact stresses and provide protection between adjacent cells, as well as absorb cell thickness variation as the cells 60 charge (thicken) or discharge (thin). It will be appreciated that stack 14 can include any number of cells 60 in various arrangements. Moreover, the battery cells 60 are electrically connected in series, parallel, or combinations thereof. The stack 14 includes a plurality of tabs or terminals 64 to electrically connect the cells 60 or other stacks 14 (not shown).

As shown in FIG. 1, spacer pads or plates 16 are disposed on opposite sides of the battery cell stack 14. In the example embodiment, the spacer plates 16 are configured to be contacted by assembly machine components when pre-compressing the battery cell stack 14, as described in more detail in FIGS. 5A and 5B. A thickness of each spacer plate 16 is chosen to provide a designed final compression (e.g., within a predefined tolerance) of battery cell stack 14 when disposed within the housing 12. For example, increasing spacer plate thickness will increase the final compression of the battery cell stack 14 and vice versa. Because the designed final compression of stack 14 is more sensitive than traditional liquid electrolyte batteries, adjusting the spacer plate thickness enables the final compression to be tightly controlled in light of manufacturing variability and size and design adjustments. In this way, varying thicknesses may be chosen to accommodate manufacturing variability in cells 60, the compression pads 62, and/or the thickness of housing 12.

With reference now to FIGS. 3 and 4, the SSBM 10 is provided with top and bottom reinforcement covers 18. In the example embodiment, once battery cell stack 14 and spacer plates 16 are pre-compressed and inserted into housing 12, the covers 18 are attached to the housing 12 to further enclose and protect the battery cell stack 14 and provide additional structural rigidity to the SSBM 10. In one example, each cover 18 is a one-piece frame fabricated from a rigid material (e.g., aluminum, steel, high strength composite, etc.), for example, via cold stamping, injection molding, or other suitable manufacturing process. However, it will be appreciated that cover 18 may be formed from a plurality of separate components (e.g., sections), which may be subsequently joined by a suitable connecting process (e.g., welding).

In the illustrated example, each cover 18 is a generally rectangular plate-like component having opposed first and second ends 70, 72 and opposed sides 74, 76. In some examples, like the one shown, one or more portions of the cover 18 are removed, for example to reduce weight while still providing a desired structural rigidity at the top and bottom of the housing 12, thereby resulting in one or more windows or apertures 78. Additionally, as shown in FIG. 3, each side 74, 76 includes a curved, inwardly extending flange 80 configured to be slidingly received within slots 82 formed in the housing 12. In the illustrated example, the slots 82 are formed in the outer surface 50 of walls 22, structural ribs 48, and mounting bosses 56. In this way, covers 18 can be attached to the housing 12 by inserting an end of flange 80 into the slots 82 and sliding the covers 18 across the top and bottom of housing 12 until positioned as shown in FIG. 4. However, it will be appreciated that covers 18 can be attached or coupled to the housing 12 in various other manners (e.g., dovetail, welding, etc.).

With reference now to FIGS. 5A and 5B, pre-compressing the battery cell stack 14 and spacer plates 16 for insertion into the housing 12 is illustrated. FIG. 5A illustrates an end view of the housing 12, battery cell stack 14, and spacer plates 16, and FIG. 5B illustrates a side view of the housing 12, battery cell stack 14, and spacer plates 16. In the example embodiment, the housing 12, battery cell stack 14, and spacer plates 16 are provided into an assembly machine 90 having one or more assembly rods 92 and/or assembly beams 94. The assembly rods/beams 92, 94 are then moved into contact with the spacer plates 16 (as shown by arrows 96) to squeeze and pre-compress the battery cell stack 14 to or slightly above the designed final compression. The assembly rods/beams 92, 94 are shaped to minimize local stress points, and as shown, multiple rods/beams may be deployed to spread the load on the spacer plate 16. With the assembly rods/beams 92, 94 continuing to provide the compressive force, the housing 12 is then inserted over the pre-compressed battery cell stack 14 and spacer plates 16.

As shown in FIG. 5B, the assembly rods/beams 92, 94 are located on the spacer plates 16 such that the cutouts 54 formed in the housing 12 provide clearance for the assembly rods/beams 92, 94. This enables the housing 12 to be lowered over the pre-compressed battery cell stack 14 and spacer plates 16 with the assembly rods/beams 92, 94 in place. Once the pre-compressed battery cell stack 14 and spacer plates 16 are inserted into the housing 12, the assembly rods/beams 92, 94 are withdrawn to allow the battery cell stack 14 to expand and compress fit within the housing 12 at the designed final compression of the stack 14.

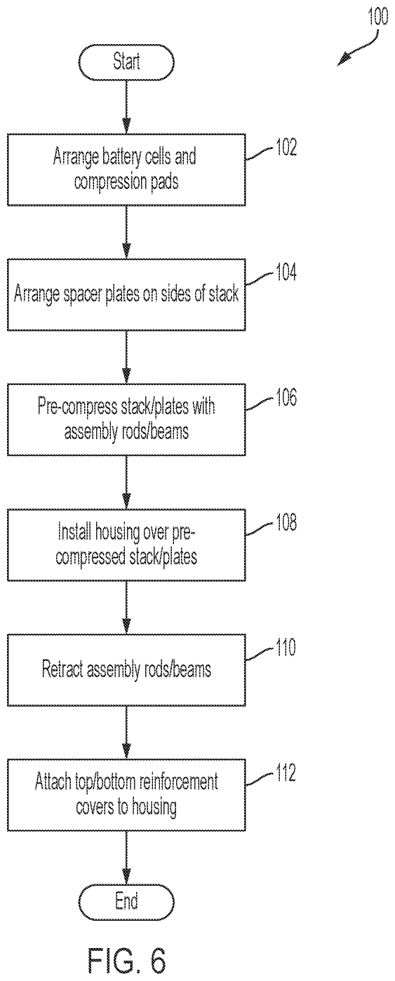

FIG. 6 illustrates an example method 100 of manufacturing the SSBM 10. The method 100 begins at step 102 where compression pads 62 are arranged between a plurality of cells 60 to form and provide solid-state battery cell stack 14. This step may be performed, for example, on an assembly table or assembly line. At step 104, one or more spacer plates 16 are provided and arranged on opposite sides of the battery cell stack 14. At step 106, the battery cell stack 14 and spacer plates 16 are pre-compressed utilizing assembly rods 92 and/or assembly beams 94. In one example, the stack 14 is pre-compressed to and/or has a final compression of between 1.0 MPa and 3.0 MPa or between approximately 1.0 MPa and approximately 3.0 MPa. However, it will be appreciated that the battery cell stack 14 may have any suitable pre-compression or final compression to provide adequate interfacing between the cell stack components.

At step 108, while pre-compressed, housing 12 is inserted (e.g., lowered) over the battery cell stack 14 and spacer plate(s) 16 with the housing cutouts 54 aligned with the assembly rods/beams 92, 94. At step 110, with the battery cell stack 14 and spacer plate(s) 16 completely within the housing 12, the assembly rods/beams 92, 94 are retracted to allow the stack 14 to expand and compress fit in the housing 12. At step 112, reinforcement covers 18 are attached to the top and bottom of the housing 12, for example by sliding the covers 18 from the side of the housing 12 into the slots 82 formed in the housing 12. This step may also be performed while the assembly rods/beams 92, 94 are compressing the stack 14.

Described herein are systems and methods for a solid-state battery module. Alternating battery cells and separator pads are arranged in a stack and spacer plates are arranged on opposite sides of the stack. Assembly rods/beams pre-compress the stack to enable a housing to be inserted over the pre-compressed stack. The assembly rods/beams are withdrawn to allow the pre-compressed stack to expand and compress fit inside the housing. Top and bottom reinforcement covers are attached to the housing to enclose and protect the battery cell stack and provide additional structural rigidity to the housing. Accordingly, the battery module advantageously has very few parts and does not require any fasteners to attach housing components.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A method of manufacturing a solid-state battery module, comprising:
providing a housing;
providing a solid-state battery cell stack;
pre-compressing the solid-state battery cell stack;
inserting, while pre-compressed, the solid-state battery cell stack into the housing; and
releasing the pre-compression of the inserted pre-compressed solid-state battery cell stack such that the solid-state battery cell stack expands to establish a compression fit within the housing.

2. The method of claim 1, further comprising:
attaching a reinforcement cover to the housing to facilitate enclosing and protecting the solid-state battery cell stack and providing additional structural rigidity to the housing.

3. The method of claim 2, wherein said attaching the reinforcement cover includes inserting a flange of the reinforcement cover into a slot formed in the housing.

4. The method of claim 2, wherein said attaching the reinforcement cover includes:
attaching a top reinforcement cover to a top side of the housing; and
attaching a bottom reinforcement cover to a bottom side of the housing.

5. The method of claim 1, further comprising arranging one or more spacer plates against an end of the solid-state battery cell stack before said pre-compressing the solid-state battery cell stack,
wherein the one or more spacer plates have a chosen thickness to accommodate manufacturing variability in the solid-state battery cell stack and/or a thickness of the housing.

6. The method of claim 1, wherein the solid-state battery cell stack is pre-compressed with a pressure between approximately 1.0 MPa and approximately 3.0 MPa.

7. The method of claim 1, wherein said pre-compressing is performed with a plurality of assembly rods and/or assembly beams squeezing opposite sides of the solid-state battery cell stack.

8. The method of claim 7, wherein the housing includes a plurality of cutouts configured to provide clearance to the plurality of assembly rods and/or assembly beams such that the housing can be inserted over the solid-state battery cell stack while being pre-compressed.

9. A solid-state battery module, comprising:
a housing; and
a pre-compressed solid-state battery cell stack,
wherein the pre-compressed solid-state battery cell stack is disposed within the housing in an expanded, compression fit with the housing.

10. The solid-state battery module of claim 9, wherein the solid-state battery cell stack comprises a plurality of battery cells separated by a plurality of compression pads.

11. The solid-state battery module of claim 9, further comprising:
a reinforcement cover coupled to the housing to facilitate enclosing and protecting the solid-state battery cell stack and providing additional structural rigidity to the housing.

12. The solid-state battery module of claim 11, wherein the reinforcement cover includes a flange configured to be inserted into a slot formed in the housing when attaching the reinforcement cover to the housing.

13. The solid-state battery module of claim 11, wherein the reinforcement cover comprises:
a top reinforcement cover coupled to a top side of the housing; and
a bottom reinforcement cover coupled to a bottom side of the housing.

14. The solid-state battery module of claim 9, further comprising a pair of spacer plates arranged on opposite sides of the solid-state battery cell stack,
wherein the spacer plates have a chosen thickness to accommodate manufacturing variability in the solid-state battery cell stack and/or a thickness of the housing.

15. The solid-state battery module of claim 9, wherein the solid-state battery cell stack is pre-compressed with a pressure between approximately 1.0 MPa and approximately 3.0 MPa, and
wherein the housing provides the support to maintain a compression of the pre-compressed solid-state battery cell stack.

16. The solid-state battery module of claim 9, wherein the housing includes a plurality of cutouts configured to provide clearance to a plurality of assembly rods and/or assembly beams such that the housing can be inserted over the solid-state battery cell stack while being pre-compressed.

17. The solid-state battery module of claim 16, wherein the plurality of assembly rods and/or assembly beams squeeze opposite sides of the solid-state battery cell stack to pre-compress the solid-state battery cell stack.

18. The solid-state battery module of claim 9, wherein the housing is a one-piece frame fabricated from a rigid material, and
wherein the housing includes a first pair of opposed walls coupled between a second pair of opposed walls to form a generally rectangular housing configured to receive the pre-compressed solid-state battery cell stack.

19. The solid-state battery module of claim 18, wherein the solid-state battery module does not require any fasteners.
